(19) United States
(12) Patent Application Publication
(10) Pub. No.: US 2006/0202099 A1
(43) Pub. Date: Sep. 14, 2006

(54) Kit and method for a universal transmission crossmember for vintage vehicles

(76) Inventor: David V. Stribling, Crawfordsville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/347,905

(22) Filed: Feb. 6, 2006

Related U.S. Application Data
(60) Provisional application No. 60/650,253, filed on Feb. 4, 2005.

(51) Int. Cl. F16M 13/02

(52) U.S. Cl. 248/544

(57) ABSTRACT

A kit and method for mounting a transmission in a vintage automobile is provided. The kit employs a central bracket and a series of supports that are adjustable during installation to allow for universal use regardless of vehicle/transmission choice, the use of oversized exhaust systems, production variations, or changes to the vehicles caused by damage or normal use.

### RELATED APPLICATION DATA

This application claims the benefit of U.S. provisional application Ser. No. 60/650,253 filed Feb. 4, 2005.

### BACKGROUND

The present invention is generally related to mounting transmissions in a vehicle. More particularly, but not exclusively, the present invention is related to a transmission mounting kit for installing a wide range of upgraded transmissions in vintage automobiles.

One of the growing areas of modification to vintage automobiles is to upgrade the transmission device to newer technology. In doing this, the existing transmission mounting bracket (also known as a cross member) is often insufficient to support the new transmission, and several manufacturers have begun marketing transmission specific brackets to fit specific car/engine combinations. However, the underbodies of vintage automobiles are often irregular, both as a result of their initial construction (e.g. older manufacturing techniques result in mounting holes not properly located) as well the stresses of age (normal wear and tear, damage from collisions, or corrosion). The specific type of engine, front suspension and transmission chosen can all effect placement of the transmission mount point, and the choice of exhaust system, particularly a larger exhaust system, can also influence the installation. As a result, it is difficult on some occasions to get the driveline (engine and transmission) at the proper recommended angle while also properly accommodating the other items (e.g. transmission shifting rod assemblies, speedometer cables, coolant tubes, and exhaust pipes) without either constructing a custom bracket or modifying one of the pre-made brackets. This increases the cost of the current modification and limits the options for future customizations. Accordingly, there is a need for improvements in this area of vehicle customization. In one embodiment, the present invention addresses this need.

### SUMMARY

The present invention provides a novel kit and method for mounting a transmission in a vehicle. While the actual nature of the invention covered herein can only be determined with reference to the claims appended hereto, certain aspects of the invention that are characteristic of the embodiments disclosed herein are described briefly as follows.

According to one aspect, a novel kit for mounting a transmission in a vehicle includes a plurality of supports for mounting the center bracket to a vehicle, the supports each including a relatively fixed mounting portion and an adjustable mounting portion, hardware for coupling the supports to the center bracket and to the underside of the vehicle; and instructions for coupling the supports to the center bracket and to the vehicle to support a transmission. In one refinement, the center bracket comprises a central transmission-supporting portion and two connecting ends, each connecting end being configured to be coupled to at least two of the supports. In another refinement, the kit includes at least eight supports, at least two of which have different lengths. In a still further refinement, the kit includes at least two connecting rods and the center bracket has at least two aligned mounting holes at each end for receiving one of the connecting rods, allowing supports to be coupled to the center bracket at various positions along the length of the connecting rods. In a refinement on this variation, the connecting rod is treaded and the hardware includes locking washers having toothed faces on opposing sides.

According to another aspect, a method for supporting a transmission in a vehicle includes: providing a mounting bracket coupled to a transmission positioned in a vehicle; providing a threaded rod in mounting holes of the bracket; selecting supports of predetermined length; coupling the supports to the vehicle; selecting a location along the length of the treaded rod; and coupling the supports at the selected locations to support the transmission in the vehicle, wherein selecting the location occurs after the supports are coupled to the vehicle. In one refinement, the supports include a fixed mounting portion and an adjustable mounting portion and the adjustable mounting portion is coupled to the threaded rod. In another variation, two supports are coupled together to create an angled support, the angled support being connected to the vehicle and to the mounting bracket. In another refinement, midsections of the supports are rigidly coupled together to increase the rigidity of the assembly. In still further variations, the length of the supports is selected based on the position of the transmission in the vehicle.

According to a still further aspect a novel method includes providing a bracket mounted to a transmission positioned in a vehicle, selecting one of multiple different supports based on the transmission and mounting locations provided in the vehicle, and mounting the supports to mounting locations in the vehicle and to the bracket to support the transmission in the vehicle.

According to a still further aspect, a novel method includes providing a bracket mounted to a transmission positioned in a vehicle, selecting one of multiple different supports based on the transmission and mounting locations provided in the vehicle, and mounting the supports to mounting locations in the vehicle and to the bracket to support the transmission in the vehicle.

In another aspect, a novel system is provided including a transmission mounting bracket having a central portion mounted to a vehicle transmission and a pair of coupling ends, the coupling ends each comprising at least two spaced apart flanges defining aligned holes; threaded connecting rods extending through the aligned holes at each coupling end; and a plurality of supports coupled to the connecting rods and to the vehicle such that the transmission is supported in the vehicle by the transmission mounting bracket, at least one of the supports comprising an adjustable mounting portion that includes a slot that extends a substantial portion of the length of the support.

These and other aspects are discussed below.

### BRIEF DESCRIPTION OF THE FIGURES

Although the characteristic features of this invention will be particularly pointed out in the claims, the invention itself, and the manner in which it may be made and used, may be better understood by referring to the following description taken in connection with the accompanying figures forming a part thereof.

FIG. 1 is a general schematic diagram showing several components of a kit according to the present invention.

FIG. 2 is a side view of one assembly of components from the FIG. 1 kit supporting a transmission.

FIG. 3 is a perspective view of another assembly of component from the FIG. 1 kit for supporting a transmission.

FIG. 4 is a perspective view of a still further assembly of components from the FIG. 1 kit for supporting a transmission.

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended. Alterations and further modifications in the illustrated devices, and such further applications of the principles of the invention as illustrated herein are contemplated as would normally occur to one skilled in the art to which the invention relates.

Turning now to the FIGS, a kit 10 and several implementations of the kit for supporting a transmission in a vehicle are disclosed. The kit 10 generally comprises a center bracket 20, a plurality of side supports 40, and connecting hardware, such as nuts 36, bolts 34, locking washers 39, and connecting rods 32, for coupling the side supports 40 to the center bracket 20 and to the vehicle to support the vehicle's transmission. The illustrated kit 10 further includes a printed instruction book 54 containing directions for properly attaching the supports 40 to the bracket 20 and to a vehicle to support the transmission.

The bracket 20 includes a planar transmission supporting surface 22 and two side flanges 29, 30 that extend downwardly from the sides of surface 22 when the bracket 22 is supporting a transmission 70. Surface 22 includes a pair of mounting slots 24 for mounting to a standard transmission bushing (not shown). The side flanges extend to the sides 28, 26 of the bracket 20 and define mounting holes 30 in their ends, which are aligned and sized to receive a threaded rod 32.

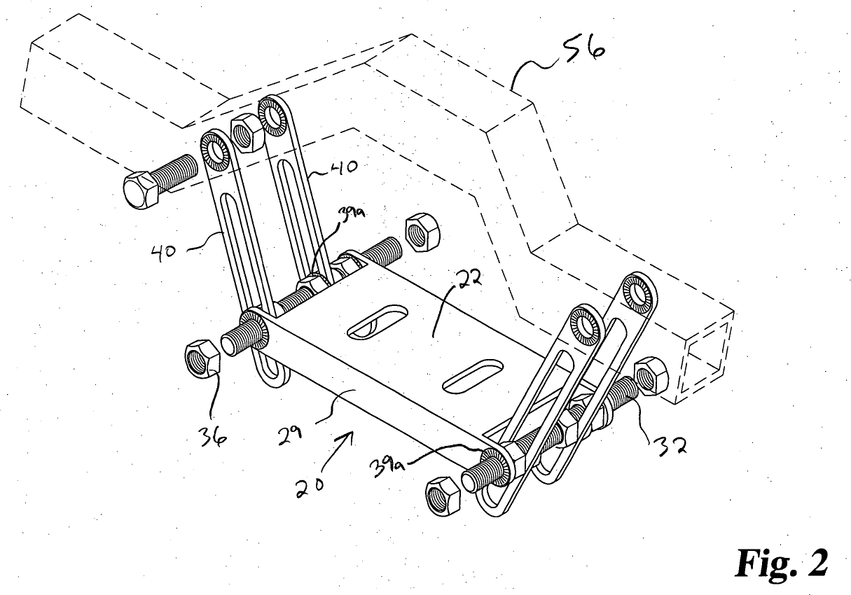

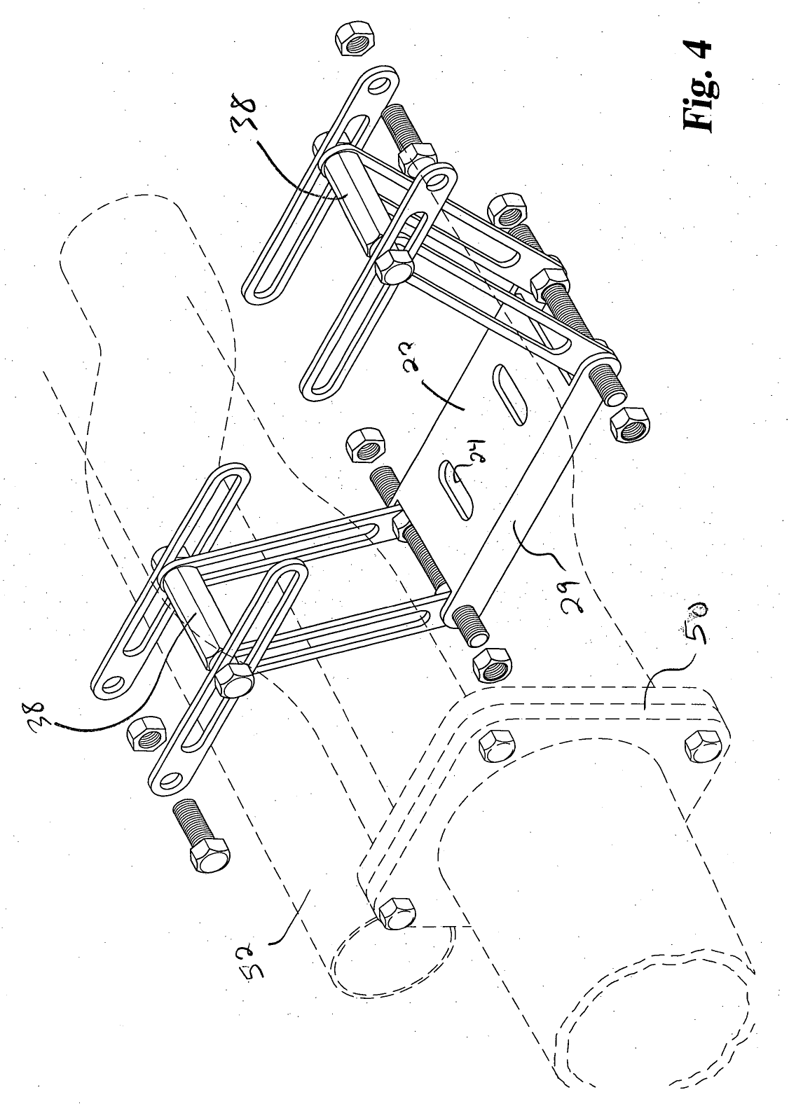

Supports 40 are used to couple the center bracket 20 to the underside 54 of the vehicle and are provided in two lengths, shorter supports 40a (e.g. 4 inches in length) and longer supports 40b (e.g. 6 inches in length). The supports may have any suitable length but typically will range between about 3 and 10 inches, for example between 3 and 7 inches. Supports 40 are coupled to the bracket via the treaded rod 32. Hardware in the form of suitably threaded nuts 36 and locking washers 39a or 39b may be used to couple the supports 40 at any convenient location along the length of rod 32, for example with the supports 40 inside (e.g. FIG. 2, 4), or outside the flanges 29, 30, spaced from (FIG. 2) or abutting (FIG. 4) the flanges 29, 30, or any combination thereof. This degree of freedom allows the user to adjust the spacing of the supports 40 to facilitate attachment to the underside 56 of the vehicle. If the full range of variation is not needed, the rod 32 need not be threaded along its entire length or a coupling other than nuts and washers may be used.

For purposes of strength and safety, the threaded rod and other connecting elements may be heat treated and/or the attachment hardware may be grade 5. To prevent vibrations from shaking any of the connections loose, locking washers 39a or 39b may be used. Washers 39a are locking washers of the type configured as a split ring, and washers 39a are washers that have serrated faces on each side that such that they bite into the supports 40 and jam nuts 36 when tightened to prevent slippage. Suitable dual serrated face washers 39b are commercially available from Nordlock-Lock (Sweden, www.nord-lock.com).

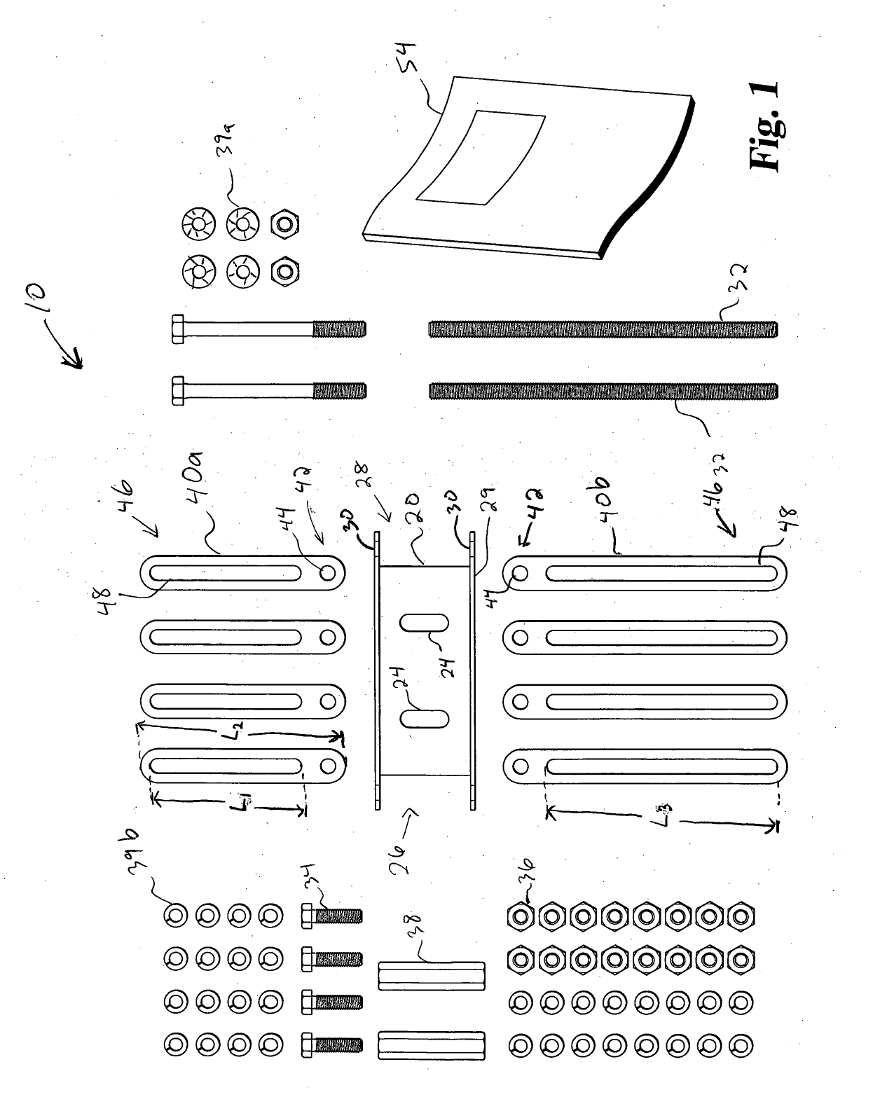

Supports 40 are each elongated rigid planar members configured to have a relatively fixed mounting portion 42 and an adjustable mounting portion 46. The adjustable mounting portion is configured to allow mounting at various locations along the length of the support 40. In the illustrated embodiment, a round hole 44 in the fixed end 44 provides the fixed mounting portion, and an elongated slot 48 provides the adjustable mounting portion. Referring to supports 40a in FIG. 1, slot 48 may have a length L1 that is a substantial fraction of the overall length L2 of the support 40, for example at least about 50 or 60% of the support's length. It is to be appreciated that this provision of adjustability also facilitates attachment to the underside 56 of the vehicle, thereby further enhancing the ability of the user to locate and align the transmission in its proper location without regard to the typical variations discussed above.

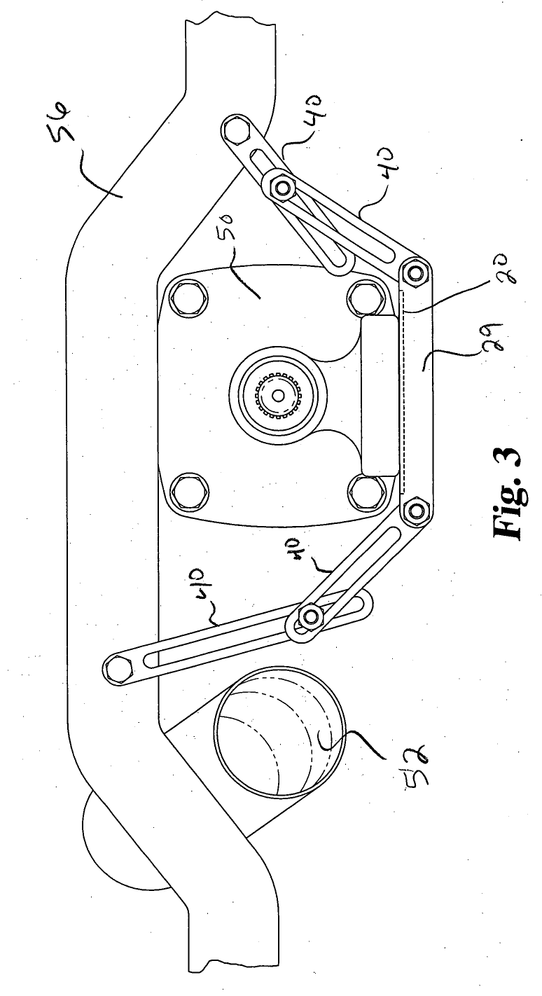

A still further degree of adjustability may be provided by constructing an angled support from two or more of the supports 40a, 40b. Examples of angled supports are depicted in FIGS. 3 and 4. This use of two supports to form an angled support may be particularly effective where other vehicle components, such as exhaust system components 52, need to be avoided. A useful technique for forming an angled support is to first attach the ends 42 to the center bracket 20 and to the vehicle's underside 56 and then to make a slot-to-slot connection between the supports 40. Alternatively, the adjustable mounting portions of the supports 40 may be attached to the center bracket 20 or the vehicle or both.

When making an angled support, rigid mounting members 38, for example 3.5 inch hex bolts, may be used to couple the two supports 40 together, as shown in FIG. 4. These rigid mounting members 38 may also be used when a pair of single support is coupled between the vehicle and the bracket 20 to provide rigidity to the assembly. In this variation, the rigid members 38 may be coupled between the supports 40 about midway between the bracket 20 and the vehicle. In a still further variation, the supports 40 may be bent in one or more directions to conform to the needs of a specific installation.

Having described the general components of the illustrated kit, it is to be understood that it may be used to support a transmission via the following procedure. First, with the engine installed, a transmission is lifted into place with a jack. The transmission bushings are installed and the center bracket 20 is finger tightened to the bushings. Two sets of side supports are loosely installed to the vehicle via their holes 42. The transmission is then fully raised into position and the correct engine/transmission angle (i.e. the driveline angle) is established and checked via appropriate angle gauges.

The user then inserts the threaded rod 32 through the holes 30 to ascertain whether the supports 40 are of proper length by positioning the supports 40 (which hang by their connected ends 42) to have their slots 48 in alignment with the rod 32. If the length is improper, the supports 40 are removed and different sized supports attached. Also, at this stage, because it has only been finger tightened, the center bracket 20 may be moved back or forth along its mounting slots 24. If proper alignment can be achieved, the rod 32, supports 40 and center bracket are secured together as described above. The hex brace 38 is then installed between the supports 40 and all connections are tightened. If desired, any excess length of the threaded rod 32 maybe cut off.

If proper alignment cannot be achieved by one or more of, adjusting the position of the center bracket on the transmission bushing, changing to different length supports 40, or changing the position of the supports along the length of the rod 32, then a dual bar installation (e.g. FIGS. 3, 4) may be required.

It is to be further understood that what has been described is a kit and methodology to install a wide range of transmissions in vintage automobiles with a fully adjustable transmission cross member. In a preferred implementation, this cross member kit may be configured to provide adjustability 6 inches up and down, side to side, and back and forth in the vehicle transmission tunnel to accommodate most popular transmissions. It may be reusable if the owner changes transmission again in the future or can be welded for permanent installation.

A suitable instruction manual for inclusion with one kit according to the present invention is the UTC Universal Transmission Cross member Owners Manual, a copy of which is included in the above referenced provisional application, Ser. No. 60/650,253, which is hereby incorporated by reference to the extent not inconsistent with the present application. It is to be understood that this instruction manual was prepared for the purpose of promoting the safe use of the particular kit intended to be sold therewith, and thus any statements in the instruction manual regarding the importance (or criticality) of particular elements, procedures or sequence of steps are not meant to be limitations of the invention. Likewise, while the invention has been illustrated and described in detail in the drawings and foregoing description, the same is to be considered as illustrative and not restrictive in character. Only certain embodiments have been shown and described, and all changes, equivalents, and modifications that come within the spirit of the invention are desired to be protected. Thus, the specifics of this description and the attached drawings should not be interpreted to limit the scope of this invention to the specifics thereof. Rather, the scope of this invention should be evaluated with reference to the claims appended hereto. For example, it is to be understood that the instructions for use need not be printed and could be communicated to the user by any other prepared means, such as via an audio tape, CD ROM or DVD or they may be communicated orally via in person training.

What is claimed is:

1. A kit for mounting a transmission in a vehicle comprising:
a center bracket;
a plurality of supports for mounting the center bracket to a vehicle, the supports each including a relatively fixed mounting portion and an adjustable mounting portion, the adjustable mounting portion comprising a slot that spans at least about 50% of the length of the support;
hardware for coupling the supports to the center bracket and to the underside of the vehicle; and
instructions for coupling the supports to the center bracket and to the vehicle to support a transmission.

2. The kit of claim 1 wherein the plurality of supports are each between 3 and 7 inches in length.

3. The kit of claim 2 wherein the slot spans at least about 60% of the length of the supports.

4. The kit of claim 1 wherein the center bracket comprises a central transmission-supporting portion and two connecting ends, each connecting end being configured to be coupled to at least two of the supports.

5. The kit of claim 4 including at least eight supports, at least two of which have different lengths.

6. The kit of claim 1 further comprising at least two connecting rods, wherein the center bracket comprises at least two aligned mounting holes at each end for receiving one of the connecting rods, and wherein the hardware allows the supports to be coupled to the center bracket at various positions along the length of the connecting rods.

7. The kit of claim 6 wherein the center bracket comprises a planar member and flanges that extend downwardly from the planar member when the center bracket is supporting the transmission, the downwardly extending flanges defining the aligned mounting holes for receiving the connecting rod.

8. The kit of claim 6 wherein the connecting rod is treaded and the hardware includes locking washers having toothed faces on opposing sides.

9. The kit of claim 4 wherein at least eight supports are included, the instructions including directions for the user to support a connecting end of the center bracket with a first and second pair of supports coupled to a second pair of supports, the first pair of supports being coupled to the vehicle and the second pair of supports being coupled to the connecting end of the center bracket.

10. A method for supporting a transmission in a vehicle comprising:
providing a mounting bracket coupled to a transmission positioned in a vehicle;
providing a threaded rod in mounting holes of the bracket;
selecting supports;
coupling the supports to the vehicle;
selecting a location along the length of the treaded rod; and
coupling the supports at the selected locations to support the transmission in the vehicle;
wherein selecting the location occurs after the supports are coupled to the vehicle.

11. The method of claim 10 wherein the supports include a fixed mounting portion and an adjustable mounting portion and the adjustable mounting portion is coupled to the threaded rod.

12. The method of claim 10 further comprising coupling two supports together to create an angled support, the angled support being connected to the vehicle and to the mounting bracket.

13. The method of claim 12 wherein each of the supports include a fixed mounting portion and an adjustable mounting portion and coupling the two supports together includes coupling the adjustable portions of two supports together.

14. The method of claim 12 wherein the angle in the support accommodates a portion of the vehicle's exhaust system.

15. The method of claim 10 wherein at least two supports are connected to each end of the mounting bracket.

16. The method of claim 15 further comprising rigidly coupling midsections of two supports together.

17. The method of claim 10 further comprising tightening the couplings between the supports and the vehicle and between the supports and the threaded rod after the supports have been coupled to both the vehicle and the treaded rod.

18. The method of claim 10 wherein the length of the supports is selected based on the position of the transmission in the vehicle.

19. A system comprising:
a transmission mounting bracket having a central portion mounted to a vehicle transmission and a pair of coupling ends, the coupling ends each comprising at least two spaced apart flanges defining aligned holes;
threaded connecting rods extending through the aligned holes at each coupling end; and
a plurality of supports coupled to the connecting rods and to the vehicle such that the transmission is supported in the vehicle by the transmission mounting bracket, at least one of the supports comprising an adjustable mounting portion that includes a slot that extends at least 60% of the length of the support.

20. The system of claim 19 wherein at least one end of the mounting bracket is supported by multiple supports coupled together in an angled configuration to accommodate a component of the vehicle.
